(19) United States
(12) Patent Application Publication
(10) Pub. No.: US 2011/0044749 A1
(43) Pub. Date: Feb. 24, 2011

(54) Apparatus For Storage and Application of Liquid Materials

(76) Inventor: Robert John Rossi, Spartanburg, SC (US)

Correspondence Address: DORITY & MANNING, P.A., POST OFFICE BOX 1449, GREENVILLE, SC, 29602-1449, US

(21) Appl. No.: 12/544,420

(22) Filed: Aug. 20, 2009

(51) Int. Cl. B43K 5/00

(52) U.S. Cl. 401/205

(57) ABSTRACT

An apparatus that can be used for the containment and application of liquid materials, such as liquid cosmetic materials is disclosed. The applicator can have a first layer and a second layer disposed beneath the first layer. The first and second layer of the applicator can be constructed of a fibrous material, such as a nonwoven fibrous material. Each of the layers of fibrous materials can have a particular specific gravity and porosity that allow for the retention of the liquid material in the second layer as well as the passage of the liquid through the first layer when the first layer and the second layer are compressed. In other embodiments, the apparatus may comprise a reservoir layer constructed of a non-woven fibrous material. Liquid material retained in the reservoir is forced from the reservoir when the reservoir is compressed.

### FIELD OF THE INVENTION

The present invention relates generally to fibrous products and more particularly to fibrous applicators for the containment and application of liquid materials.

### BACKGROUND

The containment and application of liquid materials serves many purposes. Liquid materials such as, for instance liquid paint materials, liquid ink materials, and/or liquid cosmetic materials, are often stored in containers from which the liquid materials are poured or otherwise applied to a user's fingertips or applicator device, such as a paint brush or ink stamp. Often times, manipulation of these containers can lead to spilling of the liquid material contents, leading to waste, potential damage to property, and frustration.

One type of liquid material is liquid cosmetic material. Cosmetics materials are widely used by many individuals to enhance personal appearance. Cosmetic materials include skin-care creams, lotions, powders, perfumes, lipsticks, fingernail and toe nail polish, eye and facial makeup, and many other types of products. Cosmetics are available in many different forms, including, for instance, powder form, semi-liquid form, and liquid form. An advantage of liquid cosmetic materials is that liquid cosmetics are typically easier to blend onto a user's skin.

One type of cosmetic material is foundation. Foundation is typically a flesh-toned cosmetic applied to the face to create a uniform color to the complexion, and, sometimes, to change the natural skintone of an individual. Foundation is usually available in powder form or in liquid form. Liquid foundation has advantages over other types of foundation because it allows for quick application to a user's skin and provides for good coverage over the user's skin. In addition, liquid foundation can include other desirable liquid ingredients such as, for example, moisturizers and sun protection compositions.

Many different storage containers and applicators for cosmetic materials exist. For instance, cosmetic materials are often stored in a compact case. One side of the compact case can include a pressed powder or other cosmetic material. The other side of the compact case may or may not include a mirror for application of the cosmetic material. A user can apply cosmetic material from the compact case by simply touching the cosmetic material with the user's fingertips or applicator device and applying the cosmetic material to the user's skin. Compact cases are typically not suitable for the storage of liquid cosmetics such as liquid foundation. For instance, a liquid cosmetic material would likely spill out of the compact case when opened.

Storage containers for liquid cosmetics are also known. However, the liquid foundation must typically be poured from the liquid storage container onto a users hands, fingertips or other cosmetic applicator. Such liquid cosmetic containers typically do not offer the advantages of many compact cases, namely the ability to quickly apply cosmetic materials by simply pressing a finger or other applicator device to the cosmetic material within the container. Similar difficulties can arise with the storage of other liquid materials, such as liquid paint materials or liquid ink material.

Thus, there is a need for an apparatus that can be used for the containment and application of liquid materials that overcomes the disadvantages discussed above.

### SUMMARY

Aspects and advantages of the invention will be set forth in part in the following description, or may be obvious from the description, or may be learned through practice of the invention.

One embodiment of the present invention is directed to an applicator for a liquid material. The applicator includes a first layer of fibrous material having a top surface and a bottom surface and a second layer of fibrous material having a top surface and a bottom surface. The top surface of the second layer is located beneath the bottom surface of the first layer. The second layer of fibrous material has a specific gravity and porosity sufficient to retain the liquid material. The first layer has a specific gravity that is greater than the specific gravity of the second layer. The first layer is operably connected to the second layer such that liquid material retained in the second layer passes through the first layer to the top surface of the first layer when the first layer and the second layer are compressed.

Various additions or modifications can be made to this exemplary embodiment of the invention. For instance, in variations of this particular embodiment, the first layer and the second layer can include a plurality of low-melt polyester fibers, polypropylene fibers, nylon fibers, acrylic fibers or other suitable fibers. The plurality of fibers of the first layer can have a linear mass density of about 1.5 denier to about 3.5 denier, such as about 3.0 denier. The plurality of fibers in the second layer can have a linear mass density of about 6.0 denier to about 24.0 denier, such as about 15.0 denier.

In another variation of this exemplary embodiment, the first layer can have a specific gravity of about 0.22 or greater and the second layer can have a specific gravity of about 0.15 or greater.

In another variation of this exemplary embodiment, the applicator can have a bonding layer between the first layer and the second layer. The bonding layer can include a perforated thermoplastic material to which both fibrous layers are secured thermally or by application of pressure. In other variations of this exemplary embodiment, the first layer and the second layer are bonded using a needling process.

In still another variation of this exemplary embodiment, the first layer can be been skived such that the top surface of the first layer is a smooth surface relative to the second layer. The first layer can also be made thin relative to the thickness of the second layer. For instance, the first layer can have a thickness in the range of about 1.0 mm to about 1.5 mm.

In yet another variation of this exemplary embodiment, the first layer and the second layer can be elastic such that the applicator returns to at least about 80% of its original volume after being compressed.

In yet a further variation of this exemplary embodiment, the second layer has a porosity in the range of about 70% to about 90% to allow the second layer to act as a reservoir for the liquid material.

Another exemplary embodiment of the present disclosure is directed to a fibrous applicator for a liquid cosmetics material. The applicator includes a first layer of non-woven fibrous material and a second layer of non-woven fibrous material. The first layer of non-woven fibrous material includes a plurality of fibers that define a plurality of passages to allow passage of the liquid cosmetic material through the first layer. The second layer has a specific gravity and a porosity sufficient to retain the liquid cosmetic material. The first layer of non-woven fibrous material has a specific gravity that is greater than the specific gravity of the second layer.

A further exemplary embodiment of the present disclosure is directed to an apparatus for applying a liquid cosmetic material. The apparatus includes a housing and a reservoir comprising a non-woven fibrous material disposed within the housing. The reservoir comprises a plurality of fibers having a linear mass density of about 6.0 denier to about 24.0 denier, such as about 15.0 denier. The reservoir has a specific gravity and a porosity sufficient to retain liquid cosmetic material in the reservoir.

Still a further exemplary embodiment of the present disclosure is directed to an apparatus for applying liquid cosmetic material. The apparatus includes a housing, such as a compact case housing. The apparatus further includes an applicator disposed within the housing. The applicator includes a first layer of non-woven fibrous material. The first layer includes a plurality of fibers having a linear mass density of about 1.5 denier to about 3.5 denier, such as about 3.0 denier. The apparatus also includes a second layer of non-woven fibrous material. The second layer includes a plurality of fibers having a linear mass density of about 6.0 denier to about 24.0 denier, such as about 15.0 denier. The second layer has a specific gravity and porosity sufficient to retain the liquid cosmetic material. The first layer has a specific gravity that is greater than the specific gravity of the second layer. The first layer is operably connected to the second layer such that liquid retained in the second layer passes through the first layer to a top surface of the first layer when the first layer and the second layer are compressed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary cosmetic applicator according to one exemplary embodiment of the present disclosure;

FIG. 2 provides an exploded view of an exemplary cosmetic applicator according to an exemplary embodiment of the present disclosure; and

FIG. 3 provides a cross-sectional view of an exemplary layered fibrous applicator according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

In general, the present disclosure is directed to an apparatus that can be used for the containment and application of liquid materials, such as liquid cosmetic materials, liquid paint materials, or liquid ink materials. For instance, in one embodiment, the present disclosure is directed to an applicator having a first layer and a second layer disposed beneath the first layer. The first and second layers of the applicator can be constructed of fibrous material, such as nonwoven fibrous material. Each of the layers of fibrous materials can have a particular specific gravity and porosity that allow for the retention of the liquid material in the second layer as well as the passage of the liquid through the first layer when the first layer and the second layer are compressed.

As used herein, the term “specific gravity” is intended to provide a measure of density and is defined as the ratio of the density of a given solid or liquid substance to the density of water at 4° C. (39° F.) and 1 atm (760.00 mmHg). The term “porosity” is intended to provide a measure of the amount of void spaces in a material and is defined as the ratio of void-space volume to total volume of the material expressed as a percentage from 0% to 100%.

The second layer according to embodiments of the present disclosure has a specific gravity and porosity sufficient to retain a liquid material under normal conditions, such as a liquid cosmetic material, liquid paint material, or liquid ink material. In particular, the second layer has a specific gravity and a porosity such that liquid material is actually suspended in the void spaces defined between the fibers of the second layer. In this manner, the second layer can serve as a reservoir for the liquid material.

To control the flow of the liquid material to the top surface of the applicator, the first layer can have a specific gravity that is greater than the specific gravity of the second layer. As such, the fibrous material of the first layer defines a plurality of passages that allow for the passage of liquid material from the second layer to the top surface of the first layer. When the first layer and the second layer of the applicator are compressed, the liquid material that has been retained in the second layer is forced up through the passages of the first layer to the top surface of the first layer. The higher specific gravity of the first layer controls the flow of the liquid material through the first layer. Once the liquid material reaches the top surface of the first layer, the liquid material can then be lifted from the top surface of the first layer for application onto a desirable surface.

The applicator of this exemplary embodiment may be particularly useful as an applicator for liquid cosmetic materials in, for example, a compact case. In this particular embodiment, the second layer of the applicator acts a reservoir for the liquid cosmetic material to prevent the spilling of the liquid cosmetic material while the compact case is being opened or otherwise manipulated. A user can apply the liquid cosmetic material to the user's fingertips or to another applicator device by simply pressing the user's fingertips or other applicator device to the top surface of the applicator. This will compress the first layer and the second layer of the applicator causing the liquid cosmetic material retained in the second layer to be forced upward through the first layer to the top surface of the first layer and onto the user's fingertips or other applicator device. The liquid cosmetic material can then be applied to the user's skin in a desirable manner.

Another embodiment of the present disclosure can be directed to a applicator for the containment of liquid cosmetic materials. In this particular embodiment, the housing for containment of the liquid material includes a reservoir comprised of a non-woven fibrous material. The reservoir has a specific gravity and a density sufficient to retain the liquid cosmetic material in the reservoir. When the reservoir is compressed, the liquid cosmetic material is forced from the non-woven material of the reservoir and onto a user's fingertips or applicator device as desired.

While the present disclosure makes reference to use of an applicator for storage of liquid cosmetic materials, those of ordinary skill in the art, using the disclosures provided herein, should understand that the applicator according to embodiments of the present invention can be used for the containment and application of any liquid material, such as liquid cosmetic materials, liquid paint materials, and/or liquid ink materials.

Referring to FIG. 1, an exemplary housing generally 110 including an exemplary applicator 200 according to the present disclosure is illustrated. Housing 110 has a shape and configuration as desired and may be typical of many compact cases for cosmetic materials known in the art. As illustrated, housing 110 includes an upper portion 112 and a lower portion 114. Lower portion 114 can include a space for receiving applicator 200. Upper portion 112 can include a mirror for use by an individual applying a liquid from applicator 200. In other embodiments, upper portion 112 may include a transparent window that will allow for quick examination of the contents of housing 110 without having to open housing 110.

Upper portion 112 and lower portion 114 are connected together by a hinge 116. A user can open housing 110 simply by pivoting upper portion 112 away from lower portion 114 about hinge 116. The user can then apply liquid material to the user's fingertips or other applicator device by compressing applicator 200 located in lower portion 114.

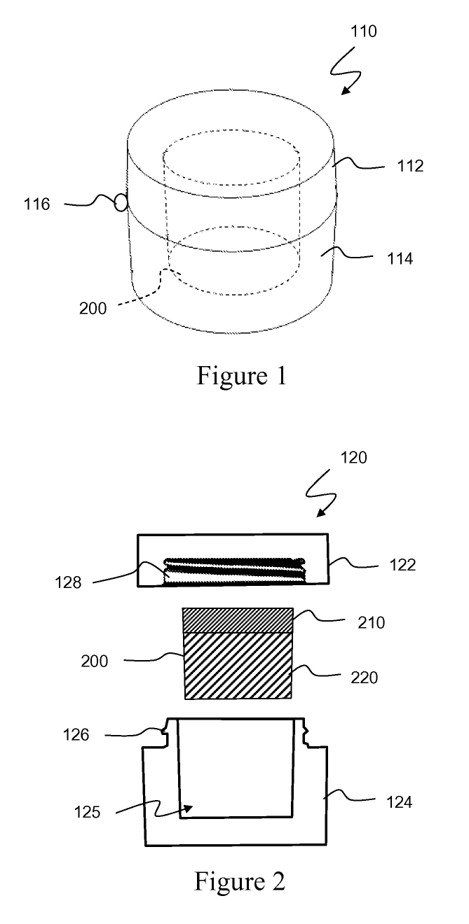

An exploded view of another exemplary housing 120 including an exemplary applicator 200 is illustrated in FIG. 2. As shown, housing 120 includes an upper portion 122 and lower portion 124. Lower portion 124 includes a space 125 for receiving applicator 200. Upper portion 122 of housing 120 includes a plurality of thread grooves 128 adapted to receive screw threads 126 located on lower portion 124. Thread grooves 128 and screw threads 126 allow for the upper portion 122 of housing 120 to be secured to lower portion 124 by simply screwing upper portion 122 onto lower portion 124.

In particular embodiments, housing 110 of FIG. 1 and/or housing 120 of FIG. 2 can be configured to provide an air tight seal for applicator 200. In this manner, liquid materials such as liquid cosmetic materials, liquid paint materials and/or liquid ink materials can be stored in housing 110 or housing 120 without evaporating and without threat of contamination from the external environment.

While FIGS. 1 and 2 depict two different exemplary housings that can be used in accordance with the present disclosure, those of ordinary skill in the art, using the disclosures provided herein, should readily understand that the present invention is not limited to any particular housing or other storage device. Indeed, applicator 200 may be used in connection with any type of housing or storage device, or may be used without any type of housing or storage device at all without deviating from the scope and spirit of the present invention.

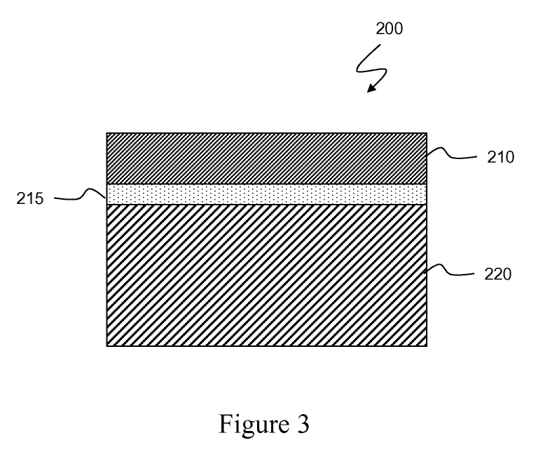

As illustrated in FIGS. 2 and 3, applicator 200 can include first layer 210 and second layer 220. First layer 210 has a top surface and a bottom surface and can be formed from a fibrous material such as a non-woven fibrous material. Second layer 220 similarly has a top surface and a bottom surface and can be formed from a fibrous material such as a non-woven fibrous material. The top surface of second layer 220 is disposed beneath the bottom surface of first layer 210.

As illustrated in FIGS. 2 and 3, first layer 210 is operably connected to second layer 220. As used herein, the term “operably connected” means connected such that liquid material retained in the second layer passes through the first layer to the top surface of the first layer when the first layer and the second layer are compressed. As illustrated in FIG. 3, the top surface 210 and second layer 220 do not have to be directly connected to one another to be operably connected, but rather can include intermediate layers, such as intermediate layer 215. Moreover, first layer 210 and second layer 220 do not have to be bonded or adhered together to be operably connected. For instance, first layer 210 may simply be placed on top of second layer 220 to be operably connected to second layer 220.

In certain embodiments, first layer 210 is bonded or adhered to second layer 220. First layer 210 and second layer 220 can be bonded or adhered together using any suitable methods or techniques known in the art. For instance, first layer 210 and second layer 220 can be directly connected together using, for instance, a needling process. As illustrated in FIG. 3, first layer 210 and second layer 220 can be connected together using an intermediate layer 215. Intermediate layer 215 can be any layer suitable for bonding or adhering first layer 210 to second layer 220. In a particular embodiment, intermediate layer 215 can be a layer of thermoplastic material. The thermoplastic material can be perforated to allow for the passage of the liquid material from the second layer 220 through the intermediate layer 215 and into the first layer 210. In particular embodiments, the perforated thermoplastic material can include a Delnet(I spaced film manufactured by Delstar Technologies, Inc.

First layer 210 can be constructed of a fibrous material such as nonwoven fibrous material. For instance, first layer 210 can include a plurality of low-melt polyester fibers, polypropylene fibers, nylon fibers, acrylic fibers or other suitable fibers. The fibrous material can allow for the retention of a liquid material without breaking down the composition of the liquid material.

It is preferred that the fibers of first layer 210 are fine such that the first layer provides a smooth surface and higher specific gravity relative to second layer 220. For instance, the fibers of first layer 210 can have a linear mass density of about 1.5 denier to about 3.5 denier, such as about 3.0 denier, or any other linear mass density or range of linear mass densities therebetween. The fine fibers of first layer 210 provide a “smooth to the touch” top surface for applicator 200. First layer 210 can also be skived or otherwise processed to provide a smoother surface. This can be particularly advantageous when applicator 200 is used to store liquid cosmetics material as users will have to repeatedly engage and depress the top surface of applicator 200 to apply the liquid cosmetics material.

In certain embodiments, first layer 210 is thin relative to second layer 220. This allows for the retention of more liquid material in applicator 200 due to the correspondingly increased size of second layer 220. In particular embodiments, first layer 210 may have a thickness in the range of about 1.0 mm to about 1.5 mm, such as about 1.25 mm, or any other thickness or range of thickness therebetween. First layer 210 may be made thin relative to second layer 220 using a skiving process or other similar process known in the art.

Similar to first layer 210, second layer 220 is also formed from a fibrous material such as a non-woven fibrous material. For instance, second layer 220 can include a plurality of low-melt polyester fibers, polypropylene fibers, nylon fibers, acrylic fibers or other suitable fibers. The fibers of second layer 220 can be course relative to the fibers of first layer 210 to provide for higher porosity and better retention of liquid material. For instance, in particular embodiments, the fibers of second layer 220 can have a linear mass density of about 6.0 denier to about 24.0 denier, such as about 10.0 denier to about 18.0 denier, such as about 15.0 denier, or any other linear mass density or range of linear mass densities therebetween.

As discussed above, second layer 220 can have a specific gravity and a porosity sufficient to retain liquid material. The fibrous material of second layer 220 defines a plurality of cavities or voids that allow for the retention of the liquid material. The amount of liquid material that can be retained in such voids is determined by the porosity and specific gravity of second layer 220. In particular embodiments, the specific gravity of second layer should be about 0.15 or greater. The porosity of second layer should be in the range of about 70% to about 90% porosity, such as about 80% porosity, or any other porosity or range of porosities therebetween.

First layer 210 should have a specific gravity that is greater than that of second layer 220. In this manner, first layer 210 can define a plurality of passages for the passage of liquid material from the reservoir second layer 220 to the top surface of first layer 210. In particular embodiments, the first layer can have a specific gravity of about 0.22 or greater.

In accordance with aspects of the present disclosure, the operation of applicator 200 will now be set forth in detail. Liquid material, such as liquid cosmetic material is retained in second layer 220. The liquid material is actually suspended in the voids or cavities defined by second layer 220. In this manner, second layer 220 acts a reservoir for the liquid material.

A user desirous of applying liquid material can bring the liquid material retained in second layer 220 to the top surface of applicator 200 by pressing the user's fingertips or other device to the top surface of first layer 210. This causes the first layer 210 and the second layer 220 to be compressed. The compression forces the liquid retained in second layer 220 through the passages defined in first layer 210 to the top surface of first layer 210. The user can then apply the liquid material in a desirous manner.

Preferably, after being compressed, the applicator 200 can return to at least about 80% of its original volume. The fibrous material of first layer 210 and second layer 220 provide a degree of elasticity to applicator 200. This degree of elasticity allows applicator 200 to return to its original shape after being compressed.

In accordance with the principles discuss above, applicator 200 can be particularly useful as a liquid cosmetic applicator in a compact case or other storage device. Second layer 220 provides for the retention of liquid cosmetic material to prevent spilling of the liquid cosmetic material during the opening or other manipulation of the compact case or other storage device. A user can apply the liquid cosmetic material by simply pressing the user's fingertips or other applicator device to the top surface of the applicator 200. The liquid cosmetic material flows through first layer 210 of applicator 200 to the user's fingertips or other applicator device so that the liquid cosmetic material can be applied in a desirous manner to the user's skin.

Although exemplary applicator 200 illustrated in FIGS. 2 and 3 includes two layers of fibrous material, those of ordinary skill in the art should recognize that the present disclosure may encompass an applicator that includes only a single reservoir layer of non-woven fibrous material. For instance, an apparatus for containment and application of a liquid cosmetic material can include a housing and a reservoir comprising a non-woven fibrous material disposed within the housing. The reservoir can include a plurality of fibers having a linear mass density of about 6.0 denier to about 24.0 denier, such as about 15.0 denier. The reservoir can have a specific gravity and a porosity sufficient to retain liquid cosmetic material in the reservoir. When the reservoir is compressed, the liquid is forced from the non-woven material of the reservoir and onto a user's fingertips or applicator device as desired.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An applicator for a liquid material, said applicator comprising:
a first layer of fibrous material having a top surface and a bottom surface;
a second layer of fibrous material having a top surface and a bottom surface, said top surface of said second layer being located beneath said bottom surface of said first layer, said second layer of fibrous material having a specific gravity and porosity sufficient to retain said liquid material;
wherein said first layer of fibrous material has a specific gravity greater than said specific gravity of said second layer and further wherein said first layer is operably connected to said second layer such that liquid material retained in said second layer passes through said first layer to said top surface of said first layer when said first layer and said second layer are compressed.

2. The applicator of claim 1, wherein said first layer and said second layer comprise a plurality of low-melt polyester fibers, polypropylene fibers, nylon fibers, or acrylic fibers.

3. The applicator of claim 1, wherein said first layer comprises a plurality of fibers having a linear mass density of about 1.5 denier to about 3.0 denier and said second layer comprises a plurality of fibers having a linear mass density of about 6.0 denier to about 24.0 denier.

4. The applicator of claim 1, wherein said first layer comprises a plurality of fibers having a linear mass density of about 3.0 denier and said second layer comprises a plurality of fibers having a linear mass density of about 15.0 denier.

5. The applicator of claim 1, wherein said first layer has a specific gravity of about 0.22 or greater and said second layer has a specific gravity of about 0.15 or greater.

6. The applicator of claim 1, wherein said applicator comprises a bonding layer between said first layer and said second layer, said bonding layer comprising a perforated thermoplastic material.

7. The applicator of claim 1, wherein said first layer and said second layer are needled together.

8. The applicator of claim 1, wherein said first layer has a thickness in the range of about 1.0 mm to about 1.5 mm.

9. The applicator of claim 1, wherein said first layer and said second layer are elastic such that said applicator returns to at least about 80% of its original volume after being compressed.

10. The applicator of claim 1, wherein said second layer of fibrous material has a porosity of about 70% to about 90%.

11. A fibrous applicator for a liquid cosmetic material, said applicator comprising:
a first layer of non-woven fibrous material, said first layer comprising a plurality of fibers defining a plurality of passages to allow passage of said liquid cosmetic material through said first layer;
a second layer of fibrous material arranged beneath said first layer of fibrous material, said second layer of fibrous material having a specific gravity and porosity sufficient to retain said liquid cosmetic material;
wherein said first layer of non-woven fibrous material has a specific gravity that is greater than said specific gravity of said second layer of non-woven fibrous material.

12. The applicator of claim 11, wherein said first layer and said second layer comprise a plurality of low-melt polyester fibers, polypropylene fibers, nylon fibers, or acrylic fibers.

13. The applicator of claim 11, wherein said first layer comprises a plurality of fibers having a linear mass density of about 1.5 denier to about 3.0 denier and said second layer comprises a plurality of fibers having a linear mass density of about 6.0 denier to about 24.0 denier.

14. The applicator of claim 11, wherein said first layer comprises a plurality of fibers having a linear mass density of about 3.0 denier and said second layer comprises a plurality of fibers having a linear mass density of about 15.0 denier.

15. The applicator of claim 11, wherein said applicator comprises a bonding layer between said first layer and said second layer, said bonding layer comprising a perforated thermoplastic material.

16. The applicator of claim 11, wherein said first layer has a thickness in the range of about 1.0 mm to about 1.5 mm.

17. The applicator of claim 11, wherein said first layer and said second layer are elastic such that said applicator returns to at least about 80% of its original volume after being compressed.

18. The applicator of claim 11, wherein said second layer of fibrous material has a porosity of about 70% to about 90%.

19. An apparatus for applying liquid cosmetic material, said apparatus comprising:
a housing;
an applicator disposed within said housing; said applicator comprising:
a first layer of non-woven fibrous material, said first layer comprising a plurality of fibers having a linear mass density of about 1.5 denier to about 3.0 denier;
a second layer of non-woven fibrous material, said second layer comprising a plurality of fibers having a linear mass density of about 6.0 denier to about 24.0 denier, said second layer having a specific gravity and porosity sufficient to retain said liquid cosmetic material;
wherein said first layer has a specific gravity that is greater than said specific gravity of said second layer and further wherein said first layer is operably connected to said second layer such that liquid material retained in said second layer passes through said first layer to said top surface of said first layer when said first layer and said second layer are compressed.

20. The apparatus of claim 19, wherein said housing is a compact case.

21. An apparatus for containment of a liquid cosmetic material, said apparatus comprising:
a housing; and
a reservoir disposed within said housing, said reservoir comprising a non-woven fibrous material, said reservoir comprising a plurality of fibers having a linear mass density of about 6.0 denier to about 24.0 denier, said reservoir having a specific gravity and porosity sufficient to retain said liquid cosmetic material;
wherein said liquid cosmetic material retained in said reservoir is forced out from said reservoir when said reservoir is compressed.
